(19) United States
(12) Patent Application Publication
(10) Pub. No.: US 2024/0426707 A1
(43) Pub. Date: Dec. 26, 2024

(54) DEVICE AND METHOD FOR PROCESSING A DIGITAL SIGNAL

(71) Applicant: Aktiebolaget SKF, Göteborg (SE)

(72) Inventors: Patrik PÄÄJÄRVI, Södra Sunderbyn (SE); James P. LEBLANC, Luleå (SE)

(21) Appl. No.: 18/741,934

(22) Filed: Jun. 13, 2024

(30) Foreign Application Priority Data
Jun. 20, 2023 (DE) 102023205738.7

(51) Int. Cl. G01M 13/045; G01P 3/02

(52) U.S. Cl. CPC G01M 13/045; G01P 3/02

(57) ABSTRACT

A device (10) for processing a digital signal (S9) of samples of a continuous signal sampled at a fixed sample rate. The continuous signal is representative of vibrations of a bearing having a stationary ring and a rotating ring that rotates concentrically relative to the stationary ring. The device (10) includes a Farrow structure (15), identifying means (16), and controlling means (17). The identifying means (16) identifies moments when the rotating ring has rotated from a predetermined rotation angle from the rotation speed of the rotating ring. The control means (17) determines couples of control values from the determined moments and to control the Farrow structure (15) from the couples of control values.

### CROSS-REFERENCE TO RELATED APPLICATION

This application claims priority to German Application No. 102023205738.7, filed Jun. 20, 2023, the entirety of which is hereby incorporated by reference.

### FIELD

The present disclosure is directed to devices for processing a digital signal and methods for processing a digital signal.

### BACKGROUND

Condition monitoring algorithms, for example to detect a fault of a bearing such as a fault of an inner raceway of the bearing, require a constant rotational speed of the bearing to work properly.

Generally, condition monitoring algorithms perform spectral analysis of the rotating bearing to detect faults from specific tones and harmonics.

Rotational speed changes of the bearing during signal measurement smears out the spectral tones reducing the ability to identify the frequencies and harmonics that may be associated with faults, for example faults of an inner raceway of the bearing or faults of the outer raceway of the bearing.

Consequently, the present disclosure intends to correct deleterious effects of rotational speed changes to perform a spectral analysis.

### SUMMARY

According to an aspect, a method for processing a digital signal comprising samples of a continuous signal sampled at a fixed sample rate, the continuous signal being representative of vibrations of a bearing comprising a stationary ring and a rotating ring capable of rotating concentrically relative to the stationary ring is proposed.

The method comprises:
identifying moments when the rotating ring has rotated from a predetermined rotation angle,
determining couples of control values from the determined moments, and
controlling a Farrow structure from the couples of control values so that the Farrow structure applies to the digital signal a time-varying sample rate conversion from the fixed sample rate to a time varying sampling, the digital signal sampled at the time varying sampling being a resulting signal.

The method permits the use of existing constant rotation speed algorithms in conditions of varying rotational speed so that repetitive attempts to obtain constant-speed data acquisition are not necessary.

Taking into account the rotation speed of the rotating ring permits to take into account auxiliary speed measurements.

Advantageously, determining couples of control values from the determined moments comprises decomposing each determined moment into a first value equal to the integer part of the determined moment and a second value equal to the fractional part of the determined moment, each couple of control values comprising the first value and the second value.

Preferably, the Farrow structure comprises:
M+1 subfilters (C_M (z), . . . , C_1 (z), C_0 (z)) filtering the samples, M+1 memory banks,
M multipliers having a variable gain, and M adders, M being an integer,
an input of each memory bank being connected to an output of a subfilter,
an output of the Mth memory bank being connected to an input of the Mth multiplier, a first input of the Mth adder being connected to an output of the Mth multiplier and a second input of the Mth adder being connected to the M−1th memory bank,
for P varying between 1 and M−1, the input of the Pth multiplier is connected to the output of the P+1th adder, the first input of the Pth adder is connected to the output of the Pth multiplier, and the second input of the Pth adder is connected to P−1 memory bank,
wherein controlling the Farrow structure comprise for each couple of control values:
   selecting the memory data item of each memory bank stored at the address equal to the first value, and
   configuring the M multipliers so that the variable gain of the M multipliers is equal to the second value.

Advantageously, determining the rotation speed of the mobile ring comprises determining a continuous estimate of the rotation speed.

Preferably, the moments are identified from the rotation angle and/or speed of the rotating ring.

According to an aspect, a device for processing a digital signal comprising samples of a continuous signal sampled at a fixed sample rate, the continuous signal being representative of vibrations of a bearing comprising a stationary ring and a rotating ring capable of rotating concentrically relative to the stationary ring is proposed.

The device comprises:
a Farrow structure,
identifying means configured to identify moments when the rotating ring has rotated from a predetermined rotation angle from the rotation angle and/or speed of the rotating ring,
control means configured to determine couples of control values from the determined moments and to control the Farrow structure from the couples of control values so that the Farrow structure apply to the digital signal a time-varying sample rate conversion from the fixed sample rate to a time varying sampling, the digital signal sampled at the time varying sampling being a resulting signal.

Advantageously, the control means are configured to decompose each determined moment into a first value equal to the integer part of the determined moment and a second value equal to the fractional part of the determined moment, each couple of control values comprising the first value and the second value.

Preferably, the Farrow structure comprises:
M+1 subfilters (C_M (z), . . . , C_1 (z), C_0 (z)) filtering the samples, M+1 memory banks,
M multipliers having a variable gain, and M adders, M being an integer,
an input of each memory bank being connected to an output of a subfilter,
an output of the Mth memory bank being connected to an input of the Mth multiplier, a first input of the Mth adder being connected to an output of the Mth multiplier and a second input of the Mth adder being connected to the M−1th memory bank,
for P varying between 1 and M−1, the input of the Pth multiplier is connected to the output of the P+1th adder, the first input of the Pth adder is connected to the output of the Pth multiplier, and the second input of the Pth adder is connected to P−1 memory bank,
wherein the control means are configured for each control value to:
   select the memory data item of each memory bank stored at the address equal to the first value, and
   configure the M multipliers so that the variable gain of the M multipliers is equal to the second value.

According to an aspect, a bearing device is proposed.

The bearing device comprises:
a bearing provided with a stationary ring and a rotating ring capable of rotating concentrically relative to the stationary ring,
a first sensor configured to measure the vibrations of the said inner or outer ring and configured to deliver a continuous signal,
first means configured to determine the rotation speed of the rotating ring,
a sampler configured to sample the continuous signal at a fixed sample rate and configured to deliver the digital signal comprising the samples, and
a device as defined above configured to process the digital signal from the rotation speed of the rotating ring delivered by the first means.

Preferably, the first means comprise a second sensor configured to measure the rotation speed of the rotating ring.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically a rotating machine according to the present disclosure;

FIG. 2 illustrates schematically an example of a device for processing a digital signal according to the present disclosure;

FIG. 3 illustrates schematically an example of a Farrow structure;

FIG. 4 illustrates schematically a method to determine the coefficients of the Farrow structure,

FIG. 5 illustrates schematically a method for processing a digital signal according to the present disclosure;

FIG. 6 illustrates schematically an example of the rotation speed of a rotating ring according to the time delivered by first means according to the present disclosure;

FIG. 7 illustrates schematically an example of the moments according to the time identified by identifying means according to the present disclosure;

FIG. 8 illustrates schematically an example of a signal delivered by the Farrow structure according to the present disclosure; and

FIG. 9 illustrates schematically examples of spectrum delivered by spectral analysis means for a steady rotation speed of a bearing, when the speed of the bearing is decreased during measurement according to the prior art and according to the present disclosure.

### DETAILED DESCRIPTION

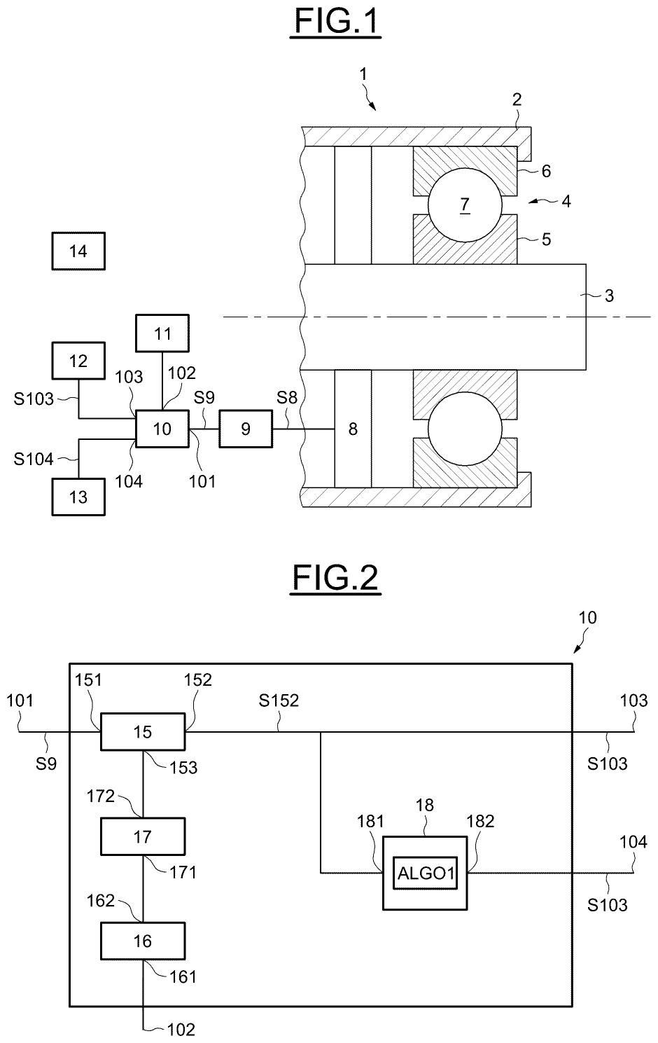

Reference is made to FIG. 1 which represents schematically a partial longitudinal cross section of a machine 1.

The machine 1 comprises a housing 2 and a shaft 3 supported in the housing 2 by a rolling bearing 4 (e.g. roller bearing or ball bearing).

The rolling bearing 4 is provided with a rotating ring 5 mounted on the shaft 3, and with a stationary ring 6 mounted into the bore of the housing 2. The stationary ring 6 radially surrounds the rotating ring 5. The rotating and stationary rings 5, 6 rotate concentrically relative to one another.

The rolling bearing 4 is further provided with a row of rolling elements 7 radially interposed between inner and outer raceways of the rotating and stationary rings 5, 6. In the illustrated example, the rolling elements 7 are balls. Alternatively, the rolling bearing may comprise other types of rolling elements 7, for example rollers. In the illustrated example, the rolling bearing comprise one row of rolling elements 7. Alternatively, the rolling bearing comprise may comprise several rows of rolling elements.

A first sensor 8 is mounted in the housing 2 to measure vibrations of the bearing 4 undergoing rotational speed changes.

The first sensor 8 may be mounted on a bore of the housing 2.

In variant, the first sensor 8 may be mounted elsewhere on the machine, near the stationary ring 6 or in the vicinity of housing 2, for example.

The first sensor 8 delivers a continuous signal S8 representative of the vibrations of the bearing 4 to an input of a sampler 9.

The sampler 9 delivers a digital signal S9 comprising multiple sequential samples xₚ of the continuous signal S8 sampled at a fixed sample rate to a first input 101 of a device 10 for processing the digital signal S9, p being an integer.

First means 11 are intended to determine the rotation speed of the rotating ring 5 and to deliver the rotation speed of the rotating ring 5 to a second input 102 of the device 10.

The first means 11 comprise for example a second sensor intended to measure the rotation speed of the rotating ring 5 or may estimate the rotation speed of the rotating ring 5 for example, from a set of pulses generated at fixed intervals of angular rotation of a shaft or wheel attached via fixation means to the rotating ring 5 or similar tachometer related methods.

The bearing 4, the first sensor 8, the sampler 9, the device 10, and the first means 11 form a bearing device.

A memory (not represented) may store the output signal S9 and delivers the output signal S9 to the device 10.

A first output 103 of the device 10 is connected to first implementing means 12 implementing at least one constant speed time domain algorithm from a first output signal S103 delivered by the device 10 on the first output 103, for example to implement an enveloping fault detection algorithm.

A second output 104 of the device 10 is connected to second implementing means 13 implementing at least one constant speed spectrally oriented algorithm from a second output signal S104 delivered by the device 10 on the second output 104, for example to implement a fast Fourier transform paired with a fault frequencies detection method.

The first and second implementing means 12, 13 are for example each made of a processing unit implementing the said algorithm.

A processing unit 14 implements the first sensor 8, the sampler 9, the device 10, and the first means 11.

FIG. 2 illustrates schematically an example of the device 10.

The device 10 comprises a Farrow structure 15 known from the document U.S. Pat. No. 4,866,647, identifying means 16, control means 17, and spectral analysis means 18.

The Farrow structure 15 comprises an input 151 connected to the input 101 of the device 10, an output 152 connected to the first output 103 of the device 10 and to an input 181 of the spectral analysis means 18, and comprises a control input 153 connected to an output 172 of the controlling means 17.

An output 182 of the spectral analysis means 18 is connected to the second output 104 of the device 10.

The spectral analysis means 18 comprise a spectral analysis algorithm ALGO1, for example a fast Fourier transform algorithm.

An input 161 of the identifying means 16 is connected to the second input 102 of the device 10 and an output of the identifying means 16 is connected to an input 171 of the controlling means 17.

The Farrow structure 15 iteratively adjusts intersample delays (resampling) of measurement data.

The Farrow structure 15 is based on a N order finite impulse response FIR filter with coefficients h(n, Δ) that may be varied by means of a control variable Δ equal to the inter-sample position or delay of the Farrow structure, n being an integer between 0 and N.

The filter coefficients h(n, Δ) are formed from a polynomial of the control variable Δ.

The coefficient h(n, Δ) is equal to:

$$h ( n , Δ ) = {\sum }_{m = 0}^{M} {C}_{mn} {Δ}^{m} \qquad ( 1 )$$

where M is the order of a set of polynomials whose value is chosen by performance needs. N and M are integers. The matrix C represents the collection of each coefficient Cₘₙ of each M-order polynomial for each filter coefficient h(n, Δ). Each Cₘₙ coefficient implements the (n+1)-tap filter implementing a delay of Δ denoted as h(n, Δ).

The coefficients Cₘₙ may be represented as a coefficient matrix C of dimension (M+1)×(N+1).

$$C = [ \begin{matrix}{C}_{00} & … & {C}_{ON} \\ ⋮ & ⋱ & ⋮ \\ {C}_{M 0} & … & {C}_{MN}\end{matrix} ] \qquad ( 2 )$$

The transfer function H(z, Δ) of the Farrow structure 15 is given by:

$$H ( z , Δ ) = {\sum }_{m = 0}^{M} {C}_{m} ( z ) \cdot {Δ}^{m} \qquad ( 3 )$$

$$with$$

$${C}_{m} ( z ) = {\sum }_{n = 0}^{N} {C}_{mn} \cdot {z}^{- n} \qquad ( 4 )$$

for m varying between 0 and M, and n varying from 0 and N.

The term Cₘ(z) refers to a subfilter of the Farrow structure 15, the Farrow structure 15 comprising M+1 subfilters.

The Farrow structure 15 delivers a signal S152 on its output 152.

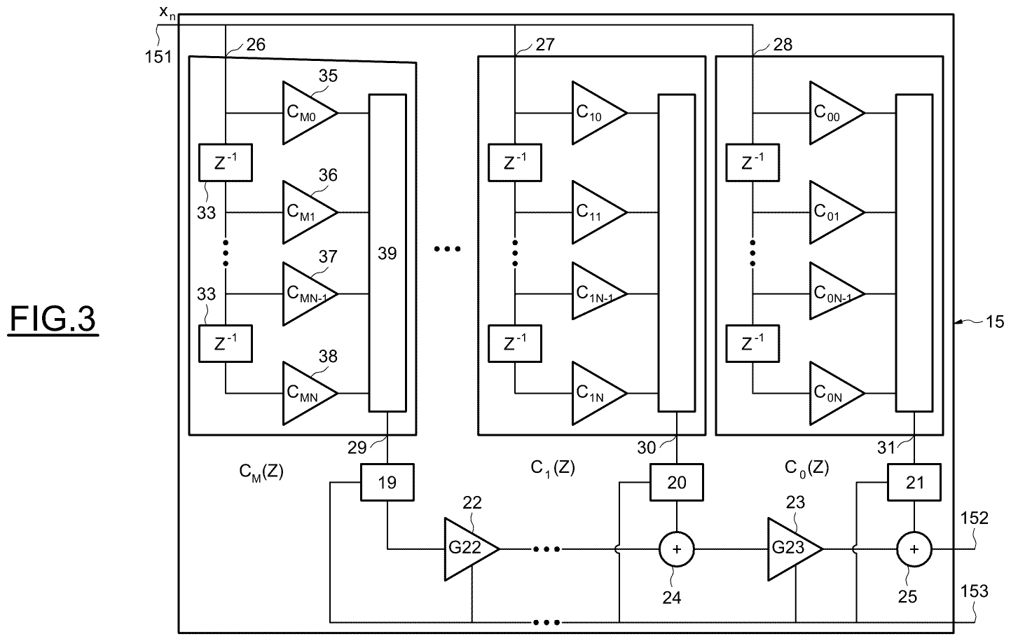

FIG. 3 illustrates schematically an example of the Farrow structure 15.

The Farrow structure 15 comprises M+1 subfilters denoted C_{M}(z), . . . , C₁(z), C₀(z), M+1 memory banks 19, 20, 21, M multipliers 22, 23 having each a variable gain G22, G23, and M adders 24, 25.

Each multiplier 22, 23 comprises an input, an output delivering a signal received on the input multiplied by the variable gain G22, G23, and a control input receiving the variable gain value.

Each adder 24, 25, comprises a first and a second inputs, and an output delivering the sum of the first and second inputs.

Each subfilter C_{M}(z), . . . , C₁(z), C₀(z) comprises an input 26, 27, 28 connected to the input 151 of the Farrow structure and an output 29, 30, 31 connected to an input of a different memory bank 19, 20, 21.

An output of the M^{th} memory bank 19 is connected to the input of the M^{th} multiplier 22.

The first input of the M^{th} adder is connected to an output of the M^{th} multiplier 22 and a second input of the M^{th} adder is connected to the M−1th memory bank.

For P varying between 1 and M−1, P being an integer, the input of the P^{th} multiplier is connected to the output of the P+1^{th} adder, the first input of the P^{th} adder is connected to the output of the P^{th} multiplier, and the second input of the P^{th} adder is connected to the P−1^{th} memory bank.

For example, as seen in FIG. 3, the output of multiplier 23 is connected to the second input of adder 25.

The output of the final adder 25 is connected to the output 152 of the Farrow structure 15.

Each memory bank 19, 20, 21 is connected to the control input 153 to select which memory data item of each memory bank 19, 20, 21 is forwarded to the multiplier G22, G23 and adders 24, 25.

The control input of the M variable gains G22, G23 is connected to the control input 153 of the Farrow structure 15 to control the value of the variable gains having each the same value.

As the structure of the subfilters C_{M}(z), . . . , C₁(z), C₀(z) is identical, only the structure of the subfilters C_{M}(z) is detailed.

The subfilter C_{M}(z) comprises a chain of N delay elements D 33, N+1 second multipliers 35, 36, 37, 38 and a second summer 39.

The N+1 second multipliers 35, 36, 37, 38 multiply N+1 sequential samples xₙ of the signal received on the input 26 of the subfilter C_{M}(z) by the N+1 filter coefficients C_{M0} to C_{MN} and deliver the multiplied sequential samples xₙ to the second summer 39.

The second summer 39 sums the N+1 sequential samples xₙ multiplied by the N+1 second multipliers 35, 36, 37, 38 and delivers the sum to the input of the memory bank 19.

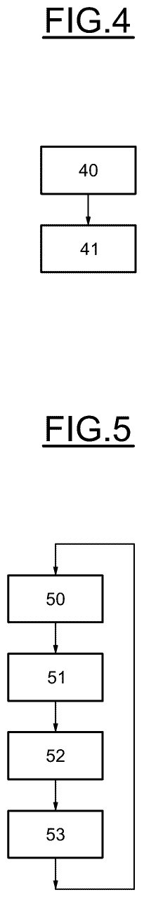

FIG. 4 illustrates an example of a known method from the prior art to determine the coefficients Cₘₙ of the coefficient matrix C of dimension (M+1)×(N+1).

In a step 40, the order N of the Farrow structure 15 and the order M of the polynomial is defined according to the required accuracy of the device 10.

At any single moment of time, the control value Δ of each multiplier G22, G23 is the same.

In another embodiment, the control value Δ of each multiplier G22, G23 may be varying on a sample by sample basis and are denoted Δₙ. The values of the fractional delay Δ n are controlled by a control unit of the device 10 (not represented) and are chosen according to the needed fractional delay to be applied to each input sample xₙ. The control unit also selects which data sample is extracted from memories 19, 20, 21 according to the fractional delay Δn to achieve the necessary integer component of the needed delay.

To provide for the implementation of a continuous range of delays, the Farrow structure relies on a polynomial curve fitting based on a set of fixed-delay reference filters. For example, assuming a bank of 8 reference filters each implementing a fixed delay, the fixed delay Δ for each reference filter could be chosen between −0.5 to 0.5 in increments of 0.125 so that the integer j varies between 0 and 7 with Δ0=−0.5, .Δ₁=−0.375, . . . Δ₇=+0.375.

In a step 41, a set of functions gⱼ(n, Δⱼ) is computed for each j value and a given n value.

The function gⱼ may be for example equal to:

$${g}_{j} ( n , {Δ}_{j} ) = \frac{sin ( π ( n - {Δ}_{j} ) )}{π ( n - {Δ}_{j} )} \qquad ( 5 )$$

In step 42, the coefficients Cₘₙ of the coefficient matrix C are determined so that for a given n value and the desired delay value Δ, the filter coefficient h(n, Δ) fits the polynomial interpolation of functions gⱼ(n, Δⱼ) defined by Cₘₙ for all values of Δ between −0.5 to +0.5.

FIG. 5 illustrates an example of implementation of the device 10.

It is assumed that the coefficient matrix C is defined and that the subfilters C_{M}(z), . . . , C₁(z), C₀(z) are parametrized according to the coefficient matrix C.

During a step 50, the sampler 9 delivers the digital signal S9 comprising the samples xₚ from the continuous signal S8 delivered by the sensor 8 and the first means 11 deliver a continuous estimate of the rotation speed of the rotating ring 5.

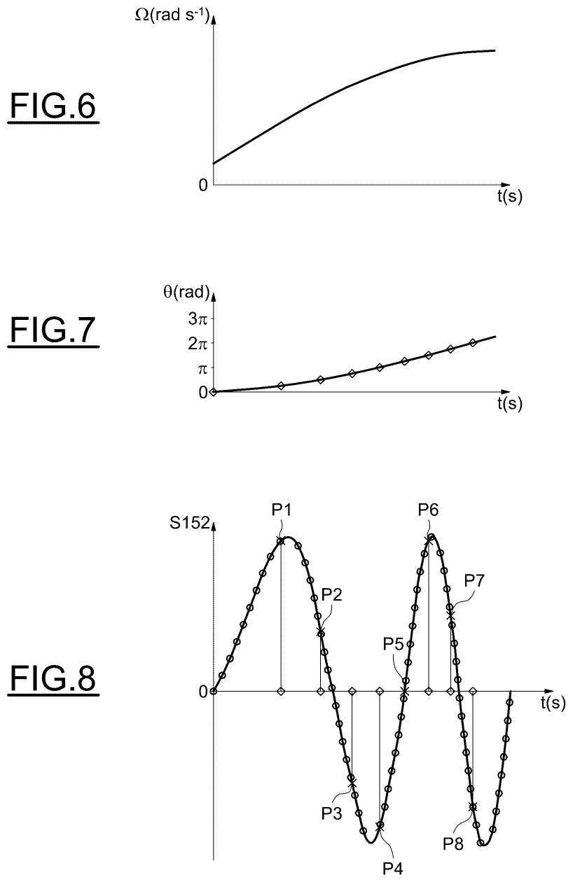

FIG. 6 illustrates an example of the rotation speed Ω of the rotating ring 5 according to the time t delivered by the first means 11.

During a step 51, the identifying means 16 identify moments when the rotating ring has rotated from a predetermined rotation angle, for example π/4.

The moments are identified by the identifying means 16 from the rotation speed Ω of the rotating ring 5, for example by integrating the rotation speed Ω.

In variant, the moments are identified by the identifying means 16 from the rotation angle θ of the rotating ring 5.

FIG. 7 illustrates an example of the moments according to the time t identified by the identifying means 16, the moments being represented by diamonds, between two adjacent moments, the rotating ring 5 has rotated from the rotation angle equal to π/4.

During a step 52, the control means 17 determine couples of control values (Δi, Δf) from the moments determined by the identifying means 16.

The control means 17 decompose each moment into a first value equal to the integer part Δi of the determined moment and a second value equal to the fractional part Δf of the determined moment, each couple of control values comprising the first value Δi and the second value Δf.

The delay Δ is such that:

$$Δ = Δ i + Δ f \qquad ( 6 )$$

During a step 53, the control means 17 control the Farrow structure 15 from the couples of control values (Δi, Δf) so that the Farrow structure 14 applies to the digital signal S9 comprising the samples xₚ a time-varying sample rate conversion from the fixed sample rate to a time varying sampling, and delivers on the output 152 of the Farrow device 15 a resulting signal comprising the digital signal sampled at the time-varying sample interval achieving speed change compensation.

The resulting signal is the first output signal S152 delivered on the output 152 of the Farrow device 15.

The time-variation of the resulting sampling depends on the values of the couples of control values (Δi, Δf) delivered by the controlling means 17.

The control means 17 selecting the memory data item of each memory bank 10, 20, 21 stored at the address equal to the first value Δi, and control the M multipliers 22, 23 so that the variable gain of the M multipliers is equal to the second value Δf.

FIG. 8 illustrates an example of the signal S152 delivered on the output 152 of the Farrow device 15.

Points P1 to P8 are determined by the Farrow device 15 so that the samples (points P1 to P8) of the signal S152 are per the predetermined rotation angle, for example π/4.

The method goes back to step 50 with the next samples xₚ delivered by the sampler 9.

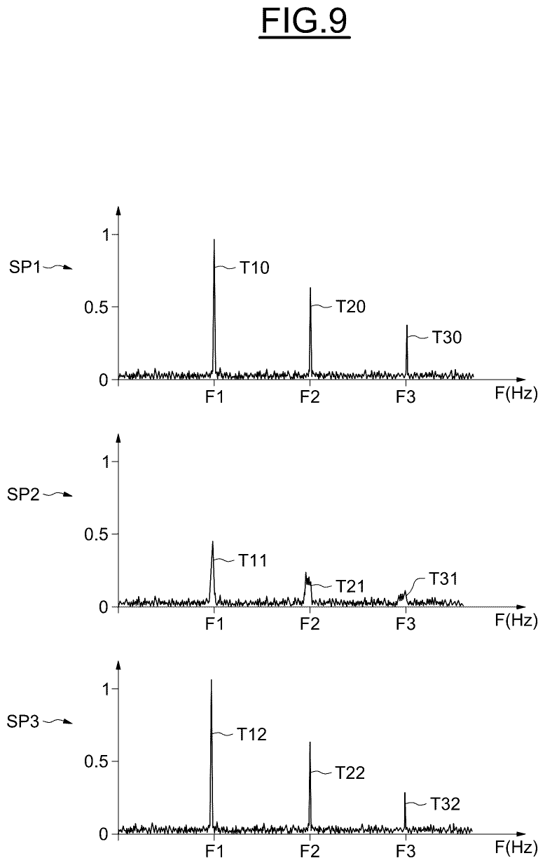

FIG. 9 illustrates the spectrum of vibrations delivered by the sensor 8 for a steady rotation speed of the bearing 4 represented by the graph SP1, the spectrum represented by the graph SP2 when the rotation speed of the bearing 4 has undergone a speed change of 3% during data collection compared to the steady rotation speed when the sensor 8 measures the rotation speed.

A graph SP3 is plotted and represents the spectrum delivered on the second output 103 of the device 10 when the rotation speed of the bearing 4 has undergone a 3% speed change during data collection after application of speed change compensation. This compares closely to the steady rotation speed.

In the graph SP1, three tones T10, T20, T30 are easily identifiable at the respective frequencies F1, F2, F3.

The tone T10 is the fundamental and the tones T20, T30 are two harmonics. The sharp characteristics of the graph SP1 is the assumed appearance of a constant speed spectrum.

In the graph SP2, three tones T11, T21, T31 having reduced peaks are hardly identifiable. It is not possible to ascertain their precise location so that the constant speed time domain algorithm implemented by the first implementing means 11 and the constant speed spectral oriented algorithm implemented by the second implementing means 12 may not ascertain if the three tones T11, T21, T31 are of interest. The skewness value of the graph SP1 is smaller than the reference skewness value.

In the graph SP3, three tones T12, T22, T33 are easily identifiable at the respective frequencies F1, F2, F3. The sharp characteristics of the original constant speed spectrum has been recovered.

The device 10 re-establishes the sharp peaks of the tones T12, T22, T32 and their frequencies F1, F2, F3.

The device 10 permits to use existing constant rotation speed algorithms when the rotation speed is varying so that repetitive attempts at data acquisition due to speed changes are not necessary.

The ability to permit use of data acquired under speed changes permits to expand the range of use cases, and allows more efficient data usage in bearing condition monitoring in general. As an example, the suppression of repetitive attempts at data acquisition permit to save supply power of a device comprising the sensor 8, the sampler 9 and the device 10, for example a wireless power comprising a supply source such as a battery.

The time-variation of the resulting sampling depends on the values of the couples of control values (Δi, Δf) delivered by the controlling means 17.

The control means 17 selecting the memory data item of each memory bank 10, 19, 20, 21 stored at the address equal to the first value Δi, and control the M multipliers 22, 23 so that the variable gain of the M multipliers is equal to the second value Δf.

The first value Δi and the second value Δf allow respectively a coarse and fine-level delay providing an accurate compensation for rotational speed changes.

Taking into account the rotation speed of the rotating ring 5 permits to take into account auxiliary speed measurements.

What is claimed is:

1. A method for processing a digital signal comprising samples of a continuous signal sampled at a fixed sample rate, the continuous signal being representative of vibrations of a bearing comprising a stationary ring and a rotating ring capable of rotating concentrically relative to the stationary ring, the method comprising:
identifying moments when the rotating ring has rotated from a predetermined rotation angle,
determining couples of control values from the determined moments, and
controlling a Farrow structure from the couples of control values so that the Farrow structure apply to the digital signal a time-varying sample rate conversion from the fixed sample rate to a time varying sampling, the digital signal sampled at the time varying sampling being a resulting signal.

2. The method according to claim 1, wherein determining moments couples of control values from the determined comprises decomposing each determined moment into a first value equal to the integer part of the determined moment and a second value equal to the fractional part of the determined moment, each couple of control values comprising the first value and the second value.

3. The method according to claim 2, wherein the Farrow structure comprises:
M+1 subfilters filtering the samples, M+1 memory banks,
M multipliers having a variable gain, and M adders, M being an integer,
an input of each memory bank being connected to an output of a subfilter,
an output of the Mth memory bank being connected to an input of the Mth multiplier, a first input of the Mth adder being connected to an output of the Mth multiplier and a second input of the Mth adder being connected to the M−1th memory bank,
for P varying between 1 and M−1, the input of the Pth multiplier is connected to the output of the P+1th adder, the first input of the Pth adder is connected to the output of the Pth multiplier, and the second input of the Pth adder is connected to P−1 memory bank,
wherein controlling the Farrow structure comprise for each couple of control values:
selecting the memory data item of each memory bank stored at the address equal to the first value, and
configuring the M multipliers so that the variable gain of the M multipliers is equal to the second value.

4. The method according to claim 1, wherein determining the rotation speed of the mobile ring comprises determining a continuous estimate of the rotation speed.

5. The method according to claim 1, wherein the moments are identified from the rotation angle and/or speed of the rotating ring.

6. The method according to claim 3, wherein determining the rotation speed of the mobile ring comprises determining a continuous estimate of the rotation speed.

7. The method according to claim 6, wherein the moments are identified from the rotation angle and/or speed of the rotating ring.

8. A device for processing a digital signal comprising samples of a continuous signal sampled at a fixed sample rate, the continuous signal being representative of vibrations of a bearing comprising a stationary ring and a rotating ring capable of rotating concentrically relative to the stationary ring, the device comprising:
a Farrow structure,
identifying means configured to identify moments when the rotating ring has rotated from a predetermined rotation angle from the rotation angle and/or speed of the rotating ring,
control means configured to determine couples of control values from the determined moments and to control the Farrow structure from the couples of control values so that the Farrow structure apply to the digital signal a time-varying sample rate conversion from the fixed sample rate to a time varying sampling, the digital signal sampled at the time varying sampling being a resulting signal.

9. The device according to claim 8, wherein the control means are configured to decompose each determined moment into a first value equal to the integer part of the determined moment and a second value equal to the fractional part of the determined moment, each couple of control values comprising the first value and the second value.

10. The device according to claim 9, wherein the Farrow structure comprises:
M+1 subfilters filtering the samples, M+1 memory banks,
M multipliers having a variable gain, and M adders, M being an integer,
an input of each memory bank being connected to an output of a subfilter,
an output of the Mth memory bank being connected to an input of the Mth multiplier, a first input of the Mth adder being connected to an output of the Mth multiplier and a second input of the Mth adder being connected to the M−1th memory bank,
for P varying between 1 and M−1, the input of the Pth multiplier is connected to the output of the P+1th adder, the first input of the Pth adder is connected to the output of the Pth multiplier, and the second input of the Pth adder is connected to P−1 memory bank,
wherein the control means are configured for each control value to:
select the memory data item of each memory bank stored at the address equal to the first value, and
configure the M multipliers so that the variable gain of the M multipliers is equal to the second value.

11. A bearing device comprising:
a bearing provided with a stationary ring and a rotating ring capable of rotating concentrically relative to the stationary ring,
a first sensor configured to measure the vibrations of the said inner or outer ring and configured to deliver a continuous signal,
first means configured to determine the rotation speed of the rotating ring,
a sampler configured to sample the continuous signal at a fixed sample rate and configured to deliver the digital signal comprising the samples, and
the device according to claim 8 configured to process the digital signal from the rotation speed of the rotating ring delivered by the first means.

12. The bearing device according to claim 11, wherein the first means comprise a second sensor configured to measure the rotation speed of the rotating ring.

13. A bearing device comprising:
a bearing provided with a stationary ring and a rotating ring capable of rotating concentrically relative to the stationary ring,
a first sensor configured to measure the vibrations of the said inner or outer ring and configured to deliver a continuous signal,
first means configured to determine the rotation speed of the rotating ring,
a sampler configured to sample the continuous signal at a fixed sample rate and configured to deliver the digital signal comprising the samples, and
a device according to claim 10 configured to process the digital signal from the rotation speed of the rotating ring delivered by the first means.

14. The bearing device according to claim 13, wherein the first means comprise a second sensor configured to measure the rotation speed of the rotating ring.
